(19) United States
(12) Patent Application Publication
(10) Pub. No.: US 2025/0315653 A1
(43) Pub. Date: Oct. 9, 2025

(54) MULTI-VENDOR SEQUENTIAL TRAINING

(71) Applicant: QUALCOMM Incorporated, San Diego, CA (US)

(72) Inventors: Abdelrahman Mohamed Ahmed Mohamed IBRAHIM, San Diego, CA (US); June NAMGOONG, San Diego, CA (US); Taesang YOO, San Diego, CA (US); Jay Kumar SUNDARARAJAN, San Diego, CA (US); Chenxi HAO, Beijing (CN); Naga BHUSHAN, San Diego, CA (US); Tingfang JI, San Diego, CA (US)

(21) Appl. No.: 18/876,636

(22) PCT Filed: Aug. 12, 2022
(86) PCT No.: PCT/CN2022/112074

§ 371 Date: Dec. 18, 2024

(51) Int. Cl. G06N 3/0455; G06N 3/08; H04W 28/02

(52) U.S. Cl. CPC G06N 3/0455; G06N 3/08; H04W 28/0252

(57) ABSTRACT

An apparatus, method and computer-readable media are disclosed for performing wireless communications. An example method of wireless communications at a first network entity associated with a first vendor includes receiving, at the first network entity, control information from at least a second network entity associated with at least a second vendor, training a first machine learning encoder and a machine learning decoder at the first network entity using the control information and transmitting, to at least the second network entity, a first decoder sequential training dataset for use in training a second machine learning encoder at the second network entity, the first decoder sequential training dataset including at least one of the control information or a latent representation of the control information output by the first machine learning encoder.

### CROSS-REFERENCE TO RELATED APPLICATIONS

This application for patent is a 371 of international Patent Application PCT/CN2022/112074, filed Aug. 12, 2022, which is hereby incorporated by referenced in its entirety and for all purposes.

### FIELD

The present disclosure generally relates to machine learning (ML) systems for wireless communications. For example, aspects of the present disclosure relate to systems and techniques for performing multi-vendor sequential training of a machine learning based decoder deployed at a network device or node (e.g., a base station such as a gNodeB (gNB) or portion thereof) that can work with multiple different types of machine learning based encoders deployed at multiple user equipment (UE) devices.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Artificial intelligence (AI) and ML based algorithms may be incorporated into the 5G and future standards to improve telecommunications and data services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for multi-vendor sequential training of a machine learning decoder deployed at a network device or node (e.g., a base station such as a gNodeB (gNB) or portion thereof, such as a central unit (CU), a distributed unit (DU), a radio unit (RU), or other portion of a base station having a disaggregated architecture) that can work with multiple different types of user equipment (UE) machine learning encoders. Vendors can be different companies that manufacture different components or devices, such as a vendor that produces mobile devices and another vendor that manufactures base stations for communicating with mobile devices.

The training of encoders and decoders occurs typically off-line. For instance, a server that is separate from a gNB may train a machine learning based decoder and then deploy the decoder for operation on the gNB. A vendor or entity such as a wireless service provider may be associated with the decoder. Similarly, a server that is associated with an entity such as a user equipment (UE) manufacturer may be used to train a machine learning based encoder. Once the encoder is trained, it can be deployed on the mobile UE or multiple UEs. One issue can be related to the fact that different entities are associated with encoders and decoders. The different entities may have proprietary information about their respective encoder(s) and decoder(s), such as the underlying neural network (NN) model and training data used to train the encoder(s) and/or decoder(s). Thus, for example, a UE manufacturer may not want to share their encoder with a wireless service provider for training in coordination with training the decoder, as the encoder may divulge at least some of the proprietary information. Aspects described herein provide example approaches to training and deployment of machine learning encoders and decoders and can be implemented on a server associated with a base station such as a gNB (e.g., for training a decoder and/or encoder), server associated with a UE (e.g., for training a decoder and/or encoder), on the UE, and/or on the base station.

In one illustrative example, a first network entity associated with a first vendor and for wireless communications is provided that includes at least one memory and at least one processor (e.g., implemented in circuitry) coupled to the at least one memory and configured to: receive, control information from at least a second network entity associated with at least a second vendor; train a first machine learning encoder and a machine learning decoder at the first network entity using the control information; and transmit, to at least the second network entity, a first decoder sequential training dataset for use in training a second machine learning encoder at the second network entity, the first decoder sequential training dataset including at least one of the control information or a latent representation of the control information output by the first machine learning encoder. The first network entity can be a base station and the second network entity can include a user equipment (UE).

In another example, a method of wireless communications at a first network entity associated with a first vendor is provided. The method includes: receiving, at the first network entity, control information from at least a second network entity associated with at least a second vendor; training a first machine learning encoder and a machine learning decoder at the first network entity using the control information; and transmitting, to at least the second network entity, a first decoder sequential training dataset for use in training a second machine learning encoder at the second network entity, the first decoder sequential training dataset including at least one of the control information or a latent representation of the control information output by the first machine learning encoder. The first network entity can include a base station and the second network entity comprises a UE.

In another aspect, a non-transitory computer-readable medium is provided having instructions that, when executed by one or more processors, cause the one or more processors to: receive, at a first network entity associated with a first vendor, control information from at least a second network entity associated with at least a second vendor; train a first machine learning encoder and a machine learning decoder at the first network entity using the control information; and transmit, to at least the second network entity, a first decoder sequential training dataset for use in training a second machine learning encoder at the second network entity, the first decoder sequential training dataset including at least one of the control information or a latent representation of the control information output by the first machine learning encoder.

In another example, an apparatus for wireless communications can include: means for receiving, at a first network entity associated with a first vendor, control information from at least a second network entity associated with at least a second vendor; means for training a first machine learning encoder and a machine learning decoder at the first network entity using the control information; and means for transmitting, to at least the second network entity, a first decoder sequential training dataset for use in training a second machine learning encoder at the second network entity, the first decoder sequential training dataset including at least one of the control information or a latent representation of the control information output by the first machine learning encoder.

In another aspect, an apparatus for wireless communications can include at least one memory and at least one processor coupled to the at least one memory. The at least one processor can be configured to: transmit, to a first network entity from the second network entity, control information for training a first machine learning encoder and a machine learning decoder at the first network entity; and receive, at the second network entity from the first network entity, a first decoder sequential training dataset for use in training a second machine learning encoder at the second network entity, the first decoder sequential training dataset comprising at least one of the control information or a latent representation of the control information output by the first machine learning encoder.

In another example, a method of wireless communications between a first network entity associated with a first vendor and a second network entity associated with a second vendor can include: transmitting, to a first network entity from the second network entity, control information for training a first machine learning encoder and a machine learning decoder at the first network entity; and receiving, at the second network entity from the first network entity, a first decoder sequential training dataset for use in training a second machine learning encoder at the second network entity, the first decoder sequential training dataset comprising at least one of the control information or a latent representation of the control information output by the first machine learning encoder.

In another aspect, a non-transitory computer-readable medium is provided having instructions that, when executed by one or more processors, cause the one or more processors to: transmit, to a first network entity from the second network entity, control information for training a first machine learning encoder and a machine learning decoder at the first network entity; and receive, at the second network entity from the first network entity, a first decoder sequential training dataset for use in training a second machine learning encoder at the second network entity, the first decoder sequential training dataset comprising at least one of the control information or a latent representation of the control information output by the first machine learning encoder.

In another example, an apparatus for wireless communications can include: means for transmitting, to a first network entity from the second network entity, control information for training a first machine learning encoder and a machine learning decoder at the first network entity; and means for receiving, at the second network entity from the first network entity, a first decoder sequential training dataset for use in training a second machine learning encoder at the second network entity, the first decoder sequential training dataset comprising at least one of the control information or a latent representation of the control information output by the first machine learning encoder.

Another aspect of this disclosure relates to the process from the standpoint of a mobile device or the UE. An apparatus for wireless communications in this regard can include at least one memory and at least one processor coupled to the at least one memory. The at least one processor can be configured to operate a user equipment machine learning encoder on a user equipment, wherein the user equipment machine learning encoder was trained according to a process including: receiving, at a first network entity associated with at least a first entity, control information from at least a second network entity associated with at least a second vendor; training the first machine learning encoder and a machine learning decoder at the first network entity using the control information and transmitting, to at least the second network entity, a first decoder sequential training dataset for use in training a second machine learning encoder at the second network entity, the first decoder sequential training dataset including at least one of the control information or a latent representation of the control information output by the first machine learning encoder, wherein the second machine learning encoder comprises the user equipment machine learning encoder.

A method for wireless communications can include operating a user equipment machine learning encoder on a user equipment, wherein the user equipment machine learning encoder was trained according to a process including: receiving, at a first network entity associated with at least a first entity, control information from at least a second network entity associated with at least a second vendor, training the first machine learning encoder and a machine learning decoder at the first network entity using the control information and transmitting, to at least the second network entity, a first decoder sequential training dataset for use in training a second machine learning encoder at the second network entity, the first decoder sequential training dataset including at least one of the control information or a latent representation of the control information output by the first machine learning encoder, wherein the second machine learning encoder comprises the user equipment machine learning encoder.

A non-transitory computer-readable storage medium comprising instructions stored thereon which, when executed by at least one processor, causes the at least one processor to perform operations according to any of the processes, methods or operations disclosed herein.

An apparatus for wireless communications comprising one or more means for performing operations according to any of the processes, methods or operations disclosed herein.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example architecture of a neural network that may be used in accordance with some aspects of the present disclosure;

FIG. 6 is a block diagram illustrating an ML engine, in accordance with aspects of the present disclosure;

FIGS. 7A-7N illustrate various block diagrams associated with providing multi-vendor sequential training, in accordance with aspects of the present disclosure;

FIGS. 8A-8C illustrate various flow diagrams associated with different aspects of multi-vendor sequential training, in accordance with aspects of the present disclosure; and

FIG. 9 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Various techniques are provided in reference with wireless technologies (e.g., The 3^{rd} Generation Partnership Project (3GPP) 5G/New Radio (NR) Standard) to provide improvements to wireless communications. The present disclosure focuses on a multi-vendor sequential training approach (e.g., a base station multi-vendor sequential training approach) in which a machine learning decoder that is trained for decoding coded control information such as, for example, channel state information (CSI) or channel state feedback (CSF), can be universal in a sense that it can receive and decode coded data from multiple different types of encoders operating on one or more UEs.

Additional aspects of the present disclosure are described in more detail below.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

In some aspects, wireless communications networks may be implemented using one or more modulation schemes. For example, a wireless communication network may be implemented using a quadrature amplitude modulation (QAM) scheme such as 16QAM, 32QAM, 64QAM, etc.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

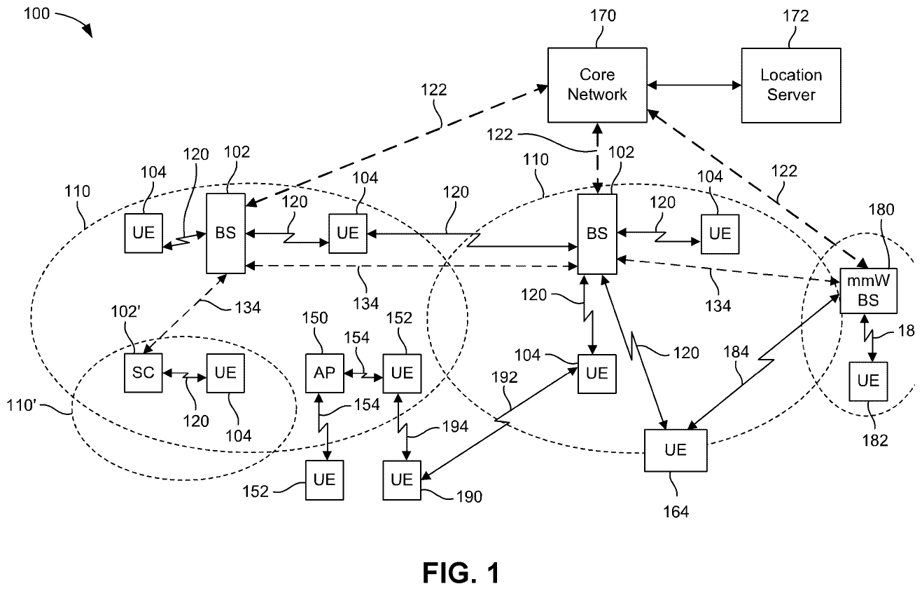

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

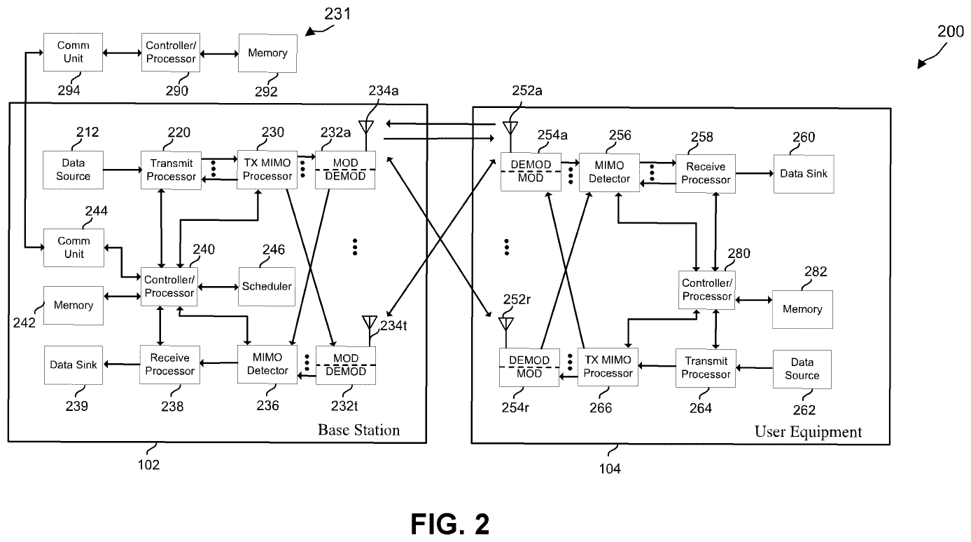

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

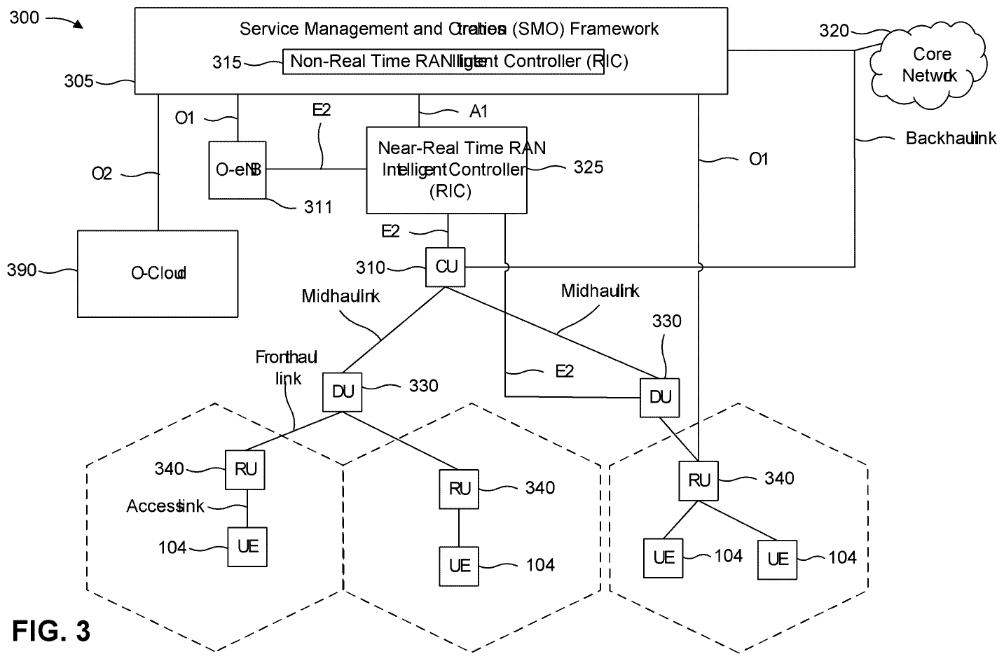

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

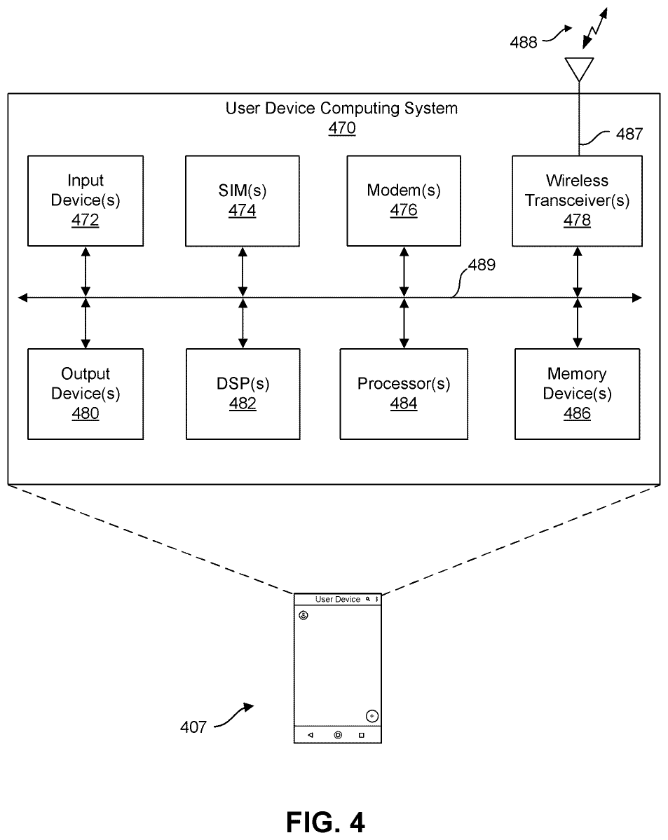

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

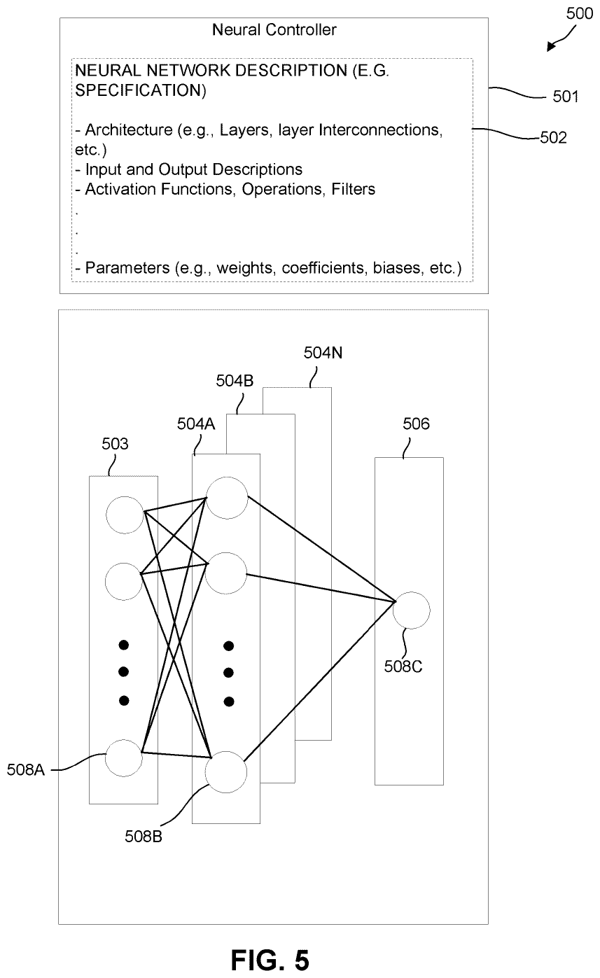

FIG. 5 illustrates an example architecture of a neural network 500 that may be used in accordance with some aspects of the present disclosure. The example architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340, and/or the UE 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feed-forward neural network. In other cases, the neural network 500 can include a recurrent neural network, which can have loops that allow information to be carried across nodes while reading in input. The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets (DBNs), a recurrent neural network (RNN), a generative-adversarial network (GAN), etc.

In the non-limiting example of FIG. 5, the neural network 500 includes an input layer 503, which can receive one or more sets of input data. The input data can be any type of data (e.g., image data, video data, network parameter data, user data, etc.). The neural network 500 can include hidden layers 504A through 504N (collectively “504” hereinafter). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503. The neural network 500 further includes an output layer 506 that provides an output resulting from the processing performed by hidden layers 504. The output layer 506 can provide output data based on the input data.

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the first hidden layer 504A. For example, as shown, each input node of the input layer 503 is connected to each node of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training data set), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

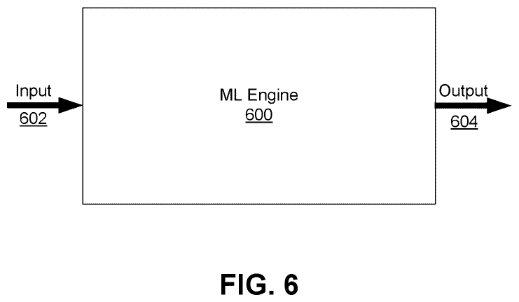

Increasingly ML (e.g., AI) algorithms (e.g., models) are being incorporated into a variety of technologies including wireless telecommunications standards. FIG. 6 is a block diagram illustrating an ML engine 600, in accordance with aspects of the present disclosure. As an example, one or more devices in a wireless system may include ML engine 600. In some cases, ML engine 600 may be similar to neural network 500. In this example, ML engine 600 includes three parts, input 602 to the ML engine 600, the ML engine, and the output 604 from the ML engine 600. The input 602 to the ML engine 600 may be data from which the ML engine 600 may use to make predictions or otherwise operate on. As an example, an ML engine 600 configured to select an RF beam may take, as input 602, data regarding current RF conditions, location information, network load, etc. As another example, data related to packets sent to a UE, along with historical packet data may be input 602 to an ML engine 600 configured to predict a DRX schedule for a UE. In some cases, the output 604 may be predictions or other information generated by the ML engine 600 and the output 604 may be used to configure a wireless device, adjust settings, parameters, modes of operations, etc. Continuing the previous examples, the ML engine 600 configured to select an RF beam may output 604 a RF beam or set of RF beams that may be used. Similarly, the ML engine 600 configured to predict a DRX schedule for the UE may output a DRX schedule for the UE.

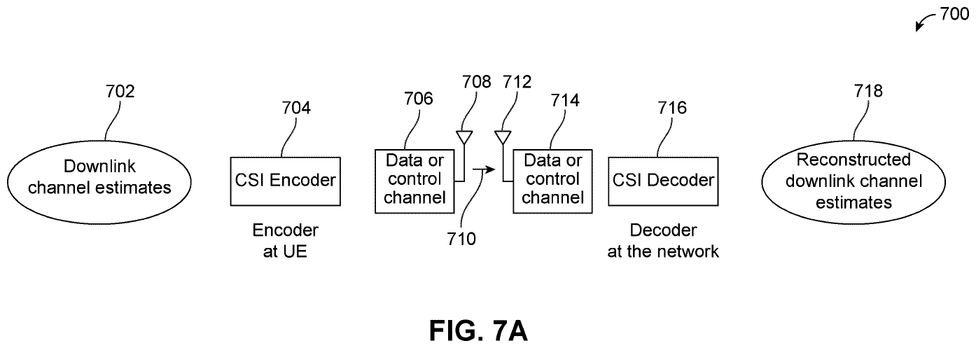

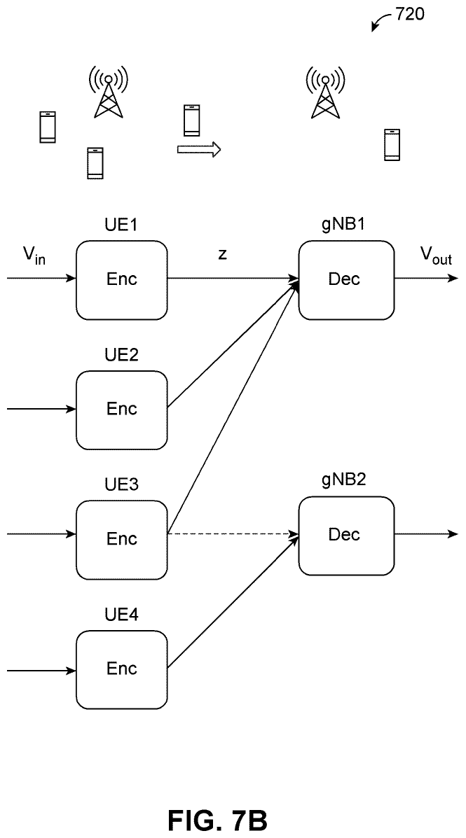

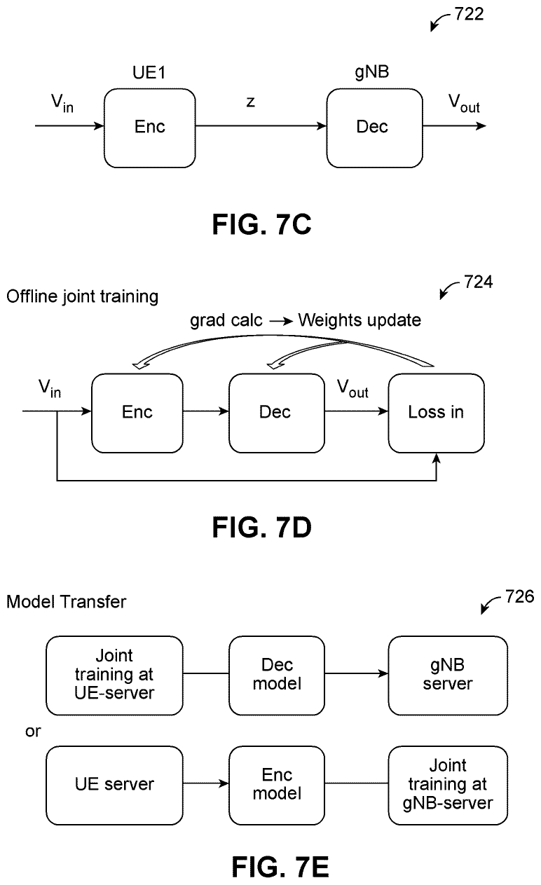

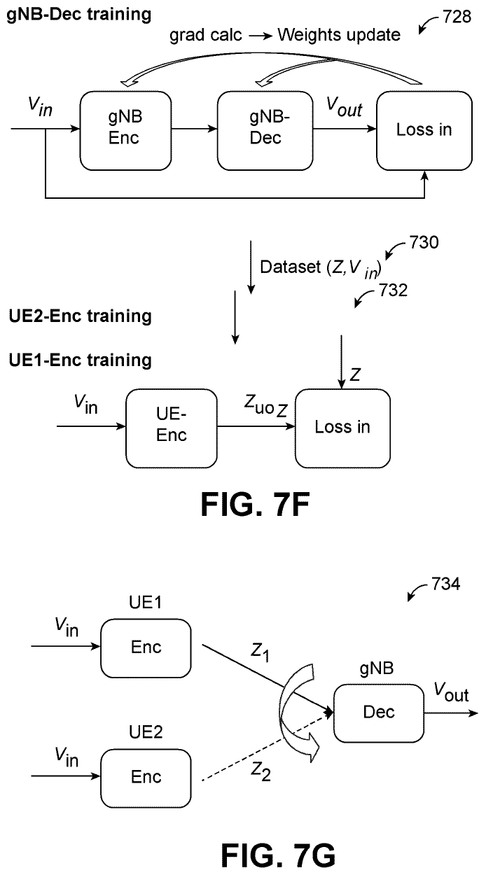

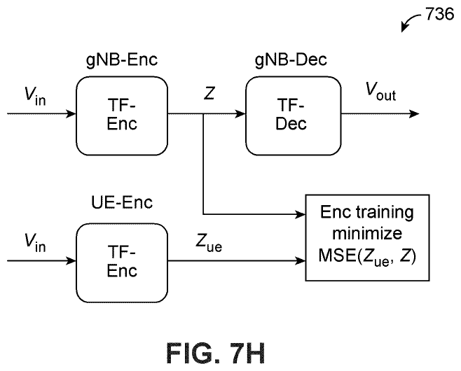

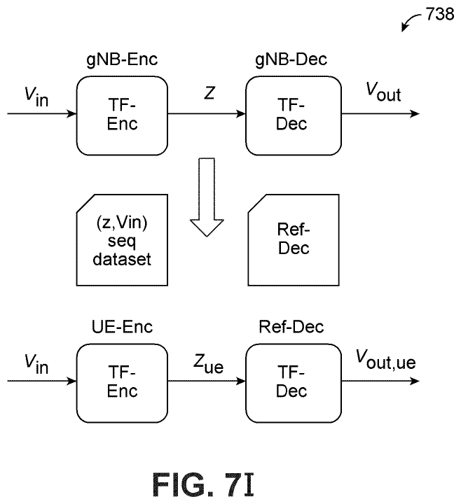

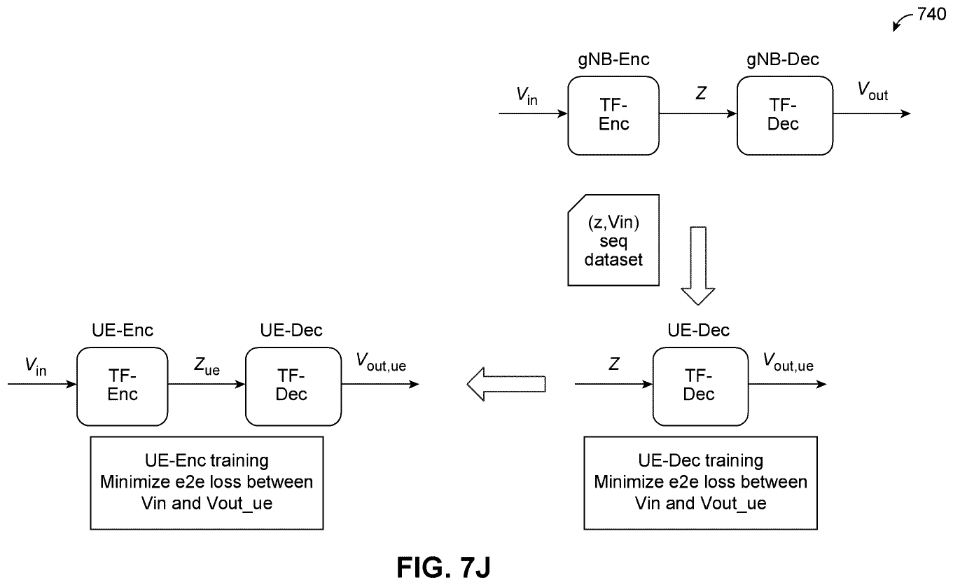

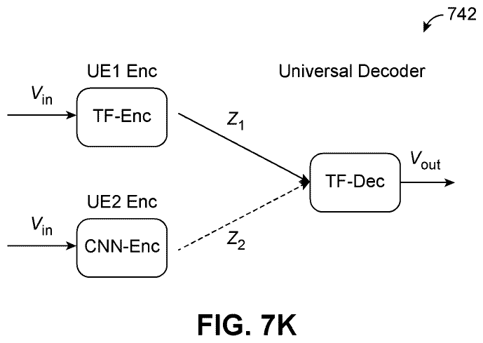

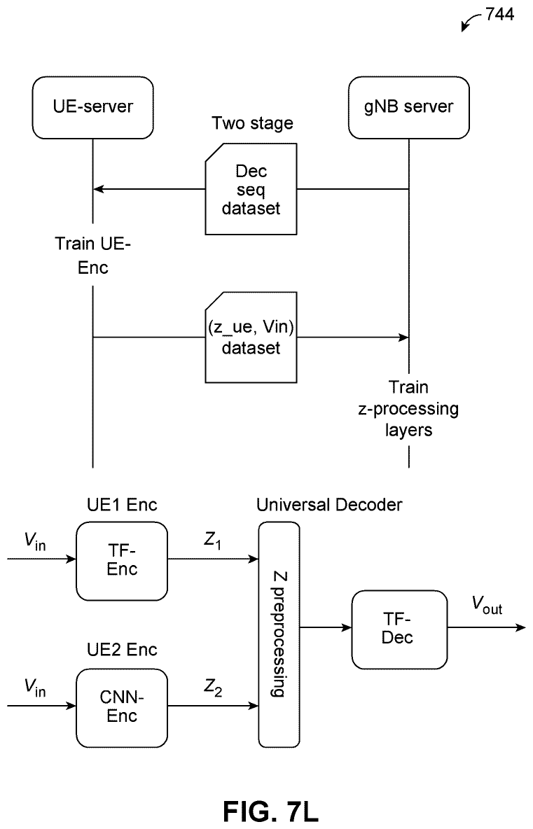

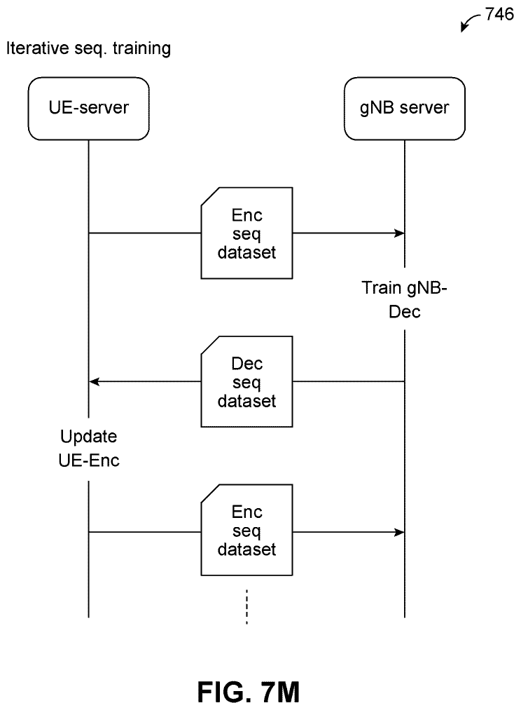

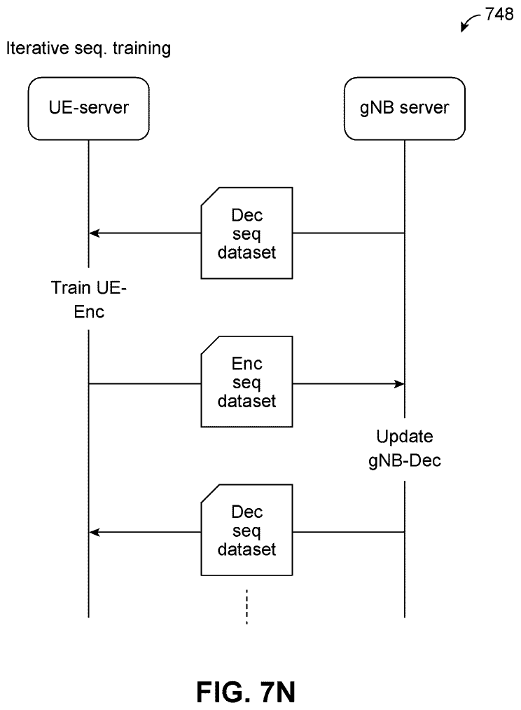

FIGS. 7A-7N are diagrams illustrating various aspects of providing a base station (e.g., gNB)-driven sequential training approach for a multi-vendor decoder. In cross-node machine learning, a neural network (NN) is split into two portions. FIG. 7A shows a network 700 with downlink channel estimates 702 provided to a channel state information (CSI) encoder 704. The CSI encoder 704 encodes CSI and transmits the encoded CSI (e.g., a latent representation of the CSI, such as a feature vector representing the CSI) using antenna 708 via a data or control channel 706 over a wireless or air interface 710 to a receiving antenna 712. The encoded CSI is provided via a data or control channel 714 to a CSI decoder 716 that can decode the encoded CSI to generate a reconstructed downlink channel estimate 718. The encoder 704 can be on a UE and the decoder can be on a base station (e.g., a gNB) or a portion of the base station (e.g., a CU, DU, RU, etc.). The encoder output from the UE is transmitted to the base station as an input to the decoder 716. In one example, the encoder at a UE outputs a compressed channel state feedback (CSF), which is input to the decoder at the base station. The decoder at the base station outputs a reconstructed CSF, such as precoding vectors. In “multi-vendor training”, each vendor (e.g. UE vendor, base station vendor) has its own server that participate in offline training of the respective encoder or decoder. The UE vendor server communicates with the base station vendor server during the training using server-to-server connections. Note that this disclosure will provide a discussion and examples in which the servers perform certain training and data exchange functions and then later the UE receives the trained encoder (from a UE server) and the base station receives the trained decoder (from a base station server) for deployment. Aspects disclosed herein can thus be system or method associated with a gNB-server, a gNB that receives and deploys a trained decoder, a UE-server and/or a UE that receives and deploys a trained encoder. In some aspects, a base station itself may train a decoder and a UE may train an encoder, without the use of respective servers.

FIG. 7B illustrates the network 720 which is useful to explain the motivation for this disclosure. Without multi-vendor training, for each UE-gNB pair, the system needs to keep different encoder-decoder pairs. Various multi-vendor scenarios include a first case where there are multi-UE vendors with one gNB vendor. This is shown with UE1 and UE2 each communicating with a gNB1 decoder. A common gNB-decoder needs to be trained to work with multiple UE-encoders. A benefit of this approach is that the gNB doesn't need to keep a separate decoder model for each UE in the cell. Further, different UE's may deploy different types of encoders as well and the gNB decoder should be able to interact with different types of encoders on different UEs.

In another case, a single-UE vendor (e.g., which provides UE3) might communicate with multi-gNB vendors (providing gNB1 and gNB2). A common UE-encoder needs in this case to be trained to work with the multiple gNB-decoders. A benefit of this approach is that the UE doesn't need to keep a separate encoder model for each gNB (e.g., when a UE moves to a new cell).

In another case, multi-UE vendors (providing multiple UEs) communicate with multi-gNB vendors (provide multiple gNBs). In this case, the UE-encoder needs to be trained to work with multiple gNB-decoders. The gNB-decoder also needs to be trained to work with multiple UE-encoders.

In some cases, one-sided concurrent training can be performed. For example, FIG. 7C shows an encoder and decoder jointly trained on one server 722. FIG. 7D illustrates offline joint training 724 in which the Vin is compared to the Vout as part of a loss function (fn) and back-propagation is used to perform a gradient calculation and update weights of the encoder and the decoder. In one-sided concurrent training, both the encoder and decoder are trained jointly on the same server. Model weights of the encoder and decoder can be both optimized jointly. FIG. 7E shows how in offline concurrent training, models (encoders and decoders) are trained offline jointly at either the UE-server or the gNB-server and then transferred to the gNB/UE for deployment 726. Note that in addition to the gNB-server receives the decoder model in FIG. 7E, the actual decoder will be deployed to the gNB. Similarly, while the UE-server is shown receiving the encoder in FIG. 7E, the encoder will ultimately be deployed on individual UEs for encoding data.

One disadvantage of a one-side concurrent training approach is that the models and potentially associated vendor data are exposed to the gNB/UE. What this means is that there may be different vendors for the gNB and the UE and when the respective servers are used to train the models, by providing the encoder model to the gNB vendor, proprietary information or data about the model might be exposed which may not be desirable for the UE vendor. Different vendors can have different sets of data or different model structures and thus would utilize separate servers for training purposes. In this case, the joint training has to be done at UE-server or gNB-server in which the encoder and the decoder models for training must both reside.

For example, a UE vendor (company A) may train both the encoder and decoder models, using its own dataset, and shares the trained decoder model with a gNB vendor (e.g., Company B or Company C). The decoder shared with the other vendor may reveal or hint at the implementation details of the UE model. Symmetry typically exists between the encoder and the decoder and thus sharing the model with a potential competitor can reveal the details of the model.

There is a need for an approach that addresses such issues. As noted previously, systems and techniques described herein provide a sequential training framework, which includes a procedure for training a universal gNB-decoder that works with multiple UE-encoders. In some cases, the UE-encoders have heterogenous architectures, e.g. UE1 has CNN-encoder (a convolutional neural network encoder) and UE2 has a transformer-encoder (a transformer (TF) type of encoder). In some cases, less powerful UE-encoders may limit performance and be a bottleneck to the system. This disclosure presents approaches to achieve multi-vendor training in scenarios such as, for example, for cross-node (e.g., two-sided) channel state feedback (CSF) (or channel state information (CSI)).

In Rel-18 AI/ML study item of a wireless standard, cross-node (X-node), such as two-sided, CSF (or CSI) is one of the use cases being studied. While the data that is encoded or decoded herein is general and can apply to different types of information (e.g., control information), one example of control information used herein for illustrative purposes is CSF and CSI. For example, a UE may report CSI to a base station using one of two types of spatial information feedback: Type I CSI feedback and Type II CSI feedback. Type I CSI feedback is a CSI feedback scheme that comprises codebook-based precoding matrix indicator (PMI) feedback with normal spatial resolution in beamforming, while Type II CSI feedback is an enhanced CSI feedback scheme that enables codebook-based feedback with higher spatial resolution in beamforming than Type I CSI feedback. Although Type II CSI feedback only allows a UE to report a rank indication (RI) of at most 2, this feedback scheme can provide higher throughput through improved beamforming and resource allocation than Type I CSI feedback by bringing more beamforming gain and separating users with higher granularity. Thus, Type II CSI feedback may be useful for multiple-user-multiple-input-multiple-output (MU-MIMO) deployment scenarios, for scenarios where the signal may be scattered (e.g., multipath), for situations where interference by other UEs may require highly granular beamforming directed toward the UE, for UE located at cell edges, etc.

However, the complexity for a UE in computing PMI for a Type II codebook may be significantly higher than that of a Type I codebook. While PMI for Type I CSI feedback is generally computed based on a single beam, PMI for Type II CSI feedback is generally computed based on the weighted sum of multiple discrete Fourier transform (DFT) beams, the value of which is comprised of the summation of the products of different wideband amplitudes, subband amplitudes, and cophasing for each beam over a number of beams L. Such CSI feedback uses significant computational power of the UE. Moreover, Type II CSI feedback may have a large overhead compared to Type I CSI feedback, since a UE using Type II CSI feedback must report the indices of L DFT beams for each layer, polarization, and beam, as well as the wideband amplitude scale, subband amplitude scale, and cophasing for each beam to the base station. With such a relatively large payload size, a UE may spend significant transmission power as well as computational power in reporting Type II CSI feedback to the base station. It can thus be challenging for a UE to determine the optimal parameters for precoding based on the size of the allowed codebook for Type II CSI feedback.

Thus, while Type II CSI feedback may be beneficial in situations where there are many other users or where the UE is at the cell edge, this feedback scheme may be less efficient in scenarios where higher spatial resolution may not be necessary. For example, Type II CSI feedback may have less performance gain in situations where the UE is located close to the base station, where there is not much interference by other UEs, or in single-user-multiple-input-multiple-output (SU-MIMO) deployments. In such cases, the gain may not outweigh the burdens of relatively large overhead and significant UE computational complexity. Hence, it would be desirable for UEs to be allowed to determine based on the channel condition whether to use a Type II codebook or to revert back to a Type I codebook when performing the CSI feedback procedure and PMI selection. Moreover, when a base station allocates uplink resources based on Type II CSI feedback for a UE to transmit precoding information in uplink control information (UCI), it would be desirable to allow the UE to signal Type I precoding information in a format that fits within the allocated resources (e.g. container) for Type II CSI feedback when the UE has determined to revert back to a Type I codebook.

The need for improvements with respect to CSI or CSF data and its encoding and transmission from a UE to a gNB, where the CSI or CSF data is decoded, is one example motivation for the gNB-driven sequential training in a multi-vendor setup as described herein.

In one illustrative aspect, a gNB-driven multi-vendor sequential training is as follows. The gNB-decoder may be trained first at gNB-server with an encoder chosen by the gNB (e.g., a CNN, GAN, RNN, etc.) and the UE-encoder may be trained based on dataset generated using this gNB-decoder. The procedure includes step0: the gNB (or gNB server) collects data from UE-servers (or directly from the UEs) to generate an aggregate training dataset (e.g., data collected can be singular vectors V); step1: the gNB-server trains the shared decoder based on aggregate dataset; Step2: the gNB-server shares the sequential training dataset with UE-servers (e.g., (z, Vin) sequential training dataset shared by gNB, where Vin is an input, such as control information, which can include CSI or CSF, and where z is a latent representation of the input) and step3: the UE-server trains UE-encoder based on sequential training dataset.

The data collected from the UE-servers can be the channel itself or the singular vectors V associated with the channel. Step0 provides one example in which the gNB (or gNB server) collects data related to the channel to develop the aggregated dataset for use in training the models. The control information may also be related to uplink control information (UCI).

In one example, as noted above, the CSI can be a precoder vector ‘V’. The gNB-server trains gNB-decoder and generates a sequential training dataset (z,Vin) which is shared with UE-server. Each UE-server trains UE-encoder based on this dataset. In one example, training UE-encoder is achieved by minimizing MSE(z, z_ue): MSE=E[∥z−zᵤₑ∥²]. MSE is the mean square error of the values provided. Other error protocols can be used as well. The value z_ue is the output of the UE-encoder.

FIGS. 7F-7G illustrate various networks 728, 732, 734 illustrating implementations of the above-described steps. In FIG. 7F, the gNB-decoder training 728 produces the dataset (z, Vin) 730 which can be provided to two different encoder training servers 732 which can include a UE1-encoder training server and a UE2-encoder training server). In FIG. 7G, the encoder training can be sequential through different encoders such as UE1-encoder and then UE2-encoder in which the training separately occurs on servers associated with different vendors and for these encoders. Note again, that after the encoders are trained on their respective servers and the decoder (universal) is trained on its server, that the respective encoders are transmitted to the actual UE's for deployment and the decoder is transmitted or transferred from the gNB-server for training to the actual gNB for deployment.

There are enhancements to the approach described above. Simulations show that gNB-driven sequential training may have lower performance compared with gNB-side concurrent training (where the encoder and decoder are trained concurrently at gNB-server). Thus, as shown in FIG. 7H, one issue is that minimizing the loss in the z-domain (e.g., MSE(z, z_ue)) 736 is not the final performance metric that the inventors care about. The end-to-end performance is more important. The system has no control on how error in z-domain affects final performance. Table 1 shows a comparison of the types of encoders and decoders (transformer or TF), the training type and the error value.

TABLE 1

| | | | SGCS |
|---|---|---|---|
| Enc | Dec | Train type | Linear |
| TF | TF | gNB-side concurrent | 0.8647 |
| TF | TF | seq (Vin, z) | 0.8506 |

The SGCS (squared generalized cosine similarity) value in the table can be, for example,

$$SGCS = E [ {\vert \frac{{V}_{in}^{H} \cdot {V}_{out}}{\vert {V}_{in} \vert \vert {V}_{out} \vert} \vert}^{2} ]$$

Table 1 shows improvement in using the sequential approach disclosed herein as opposed to the gNB-side concurrent training approach. The “TF” (or transformer) type encoder and decoder represents an example model.

FIG. 7I shows an enhancement 738 to the gNB-driven approach. In the gNB-driven approach, the gNB initiates the process. The concept in this case is to enable training of the UE-encoder based on an end-to-end loss function. To achieve this goal, the gNB-server shares in a first option, a reference decoder NN (neural network) or Ref-decoder and the Vin value with the UE-encoder server. Sharing of the ‘z’ value may not be needed in this proposal. See in FIG. 7H where the z value is provided from the gNB-server to the UE-server in order to minimize the error between Zue and z. The Ref-decoder is used by the UE-server to generate Vout_ue based on output of UE-encoder z_ue. This enables UE-server to train UE-encoder based on the end-to-end loss between Vin and Vout_ue. The Ref-decoder does not have to be the same decoder used for training on the gNB-server for training, thus the Ref-decoder can be used to not reveal or preserve the privacy of the actual gNB-decoder. An additional advantage of using the Ref-decoder is that the z value does not need to be shared from the gNB-server to the UE-server as part of the training process. Now the Ref-decoder can be used to minimize the end-to-end loss between Vin and Vout_ue as shown in FIG. 7I.

Another enhancement 740 is shown in FIG. 7J. In this case, the goal is also to enable training of the UE-encoder based on end-to-end loss function. The gNB-server shares the data (z,Vin,Vout) instead of just the data (z,Vin). The UE-server then uses (z,Vout) to train a UE-decoder neural network (shown by way of example as TF-Dec) as shown in the figure. Then, the data (z, Vin) is used to train the UE-encoder based on to end-to-end loss function, which is calculated based on UE-decoder and is the loss between Vin and Vout-ue.

FIG. 7K illustrates a two-stage training approach 742 for training a universal gNB-decoder. There are different architectures for designing the universal decoder. In one option, the gNB-decoder is used to generate the sequential training dataset is used as the shared decoder. In this case, no special handling of z's from different UEs is needed. This approach does not require any special handling for the different z1, z2 values from different UEs. This approach may lead to performance loss. The reference to “TF-Enc” and “CNN-Enc” and “TF-Dec” represent different example types of models or encoders and decoders. This disclosure is not limited to these specific types.

FIG. 7L illustrates another aspect 744 of a two-stage training approach. Again, the approach takes into account that there are different architectures for designing the universal decoder. The decoder sequential dataset is transmitted from the gNB-server to the UE-server. The UE-server then trains the UE-encoder and produces z_ue and Vin as a dataset. The UE-server transmits z_ue and Vin to the gNB-server for further training and to train z-processing layers. In this approach, z preprocessing as shown is followed by a shared universal decoder. After the first stage where UEs train encoders based on sequential training dataset, in a second stage, z preprocessing layers are trained based on dataset (z_ue, Vin) shared by the UE-servers. In one alternative, the shared decoder weights are fixed and here is no update. In this case, you would only tune the z preprocessing layer. In an alternate approach, the shared decoder weights are updated with z-preprocessing training. In one example, a “conditioning plus simple neural network” approach can include z's from different UEs that are concatenated with 1-hot encoding. The simple NN maps encoded z back to original z dimension that can be then used for two-sided preprocessing.

The universal decoder in FIG. 7L is shown as including the z processing which can in one example aggregates different z's (z1, z2) from different encoders. There is training or backpropagation using an error or other type of loss to map the encoded z back to an original z dimension.

FIG. 7M illustrates another approach 746 for sequential training for multi-vendor encoders. Multi-vendor iterative sequential training can follow one of the following approaches. In one approach 746, the process starts with a UE-driven approach in a first iteration with the following steps: Step0: the gNB-server acquires sequential training dataset from UE-server; step1: the gNB-server trains gNB-decoder based on this dataset; step2: the gNB generates a new sequential training dataset based on trained gNB-decoder; step3: update the UE-encoder based on the sequential training dataset from step2 and step3: repeat steps 0-3 for ‘X’ number of iterations. In this manner, the UE-server can update or train the UE-encoder just using the sequential training data set and does not have to share its data or encoder model with another entity or company to achieve training of the encoder. Note that there are a number of different parameters that can determine how many iterations may occur in the iterative sequential training process.

FIG. 7N illustrates another optional approach 748 for sequential training for multi-vendor encoders. This approach 746 starts with a gNB-driven approach in first iteration with the following steps: Step0: the UE-server acquires a sequential training dataset from a gNB-server; step1: the UE-server trains UE-encoder based on this dataset; step2: the UE-server generates and sends a new sequential training dataset based on trained UE-encoder; step3: the gNB-decoder updates the decoder based on sequential training dataset from step2 and step4: repeat steps 0-1 for ‘X’ number of iterations. The number of iterations can be chosen based on different parameters for example the system may achieve a level of accuracy at a threshold, or based on other parameters.

Note that FIGS. 7M and 7N show one UE-server that communicates with the gNB server for training. However, in practice, the one UE-server represents one or more UE-servers and the same process can occur to train the decoder at the gNB to operate with a number of different types of encoders trained by different UE-servers. In this manner, the same universal decoder on the gNB server will be updated or trained for the different encoders across different UE-servers.

Note that the updates can occur via a wired connection between different servers but in another case the update can occur over an air interface or with a wireless communication channel. For example, encoders and decoders might be trained on servers that have a wired connection and then as the encoder is deployed on the UE and the decoder is deployed on the gNB, there might be a smaller data set that would be used and transmitted via a wireless interface to update or tune the encoder or decoder. Thus, after deployment, the gNB and/or the UE may generate z and Vin values for the purpose of fine tuning the encoder or decoder.

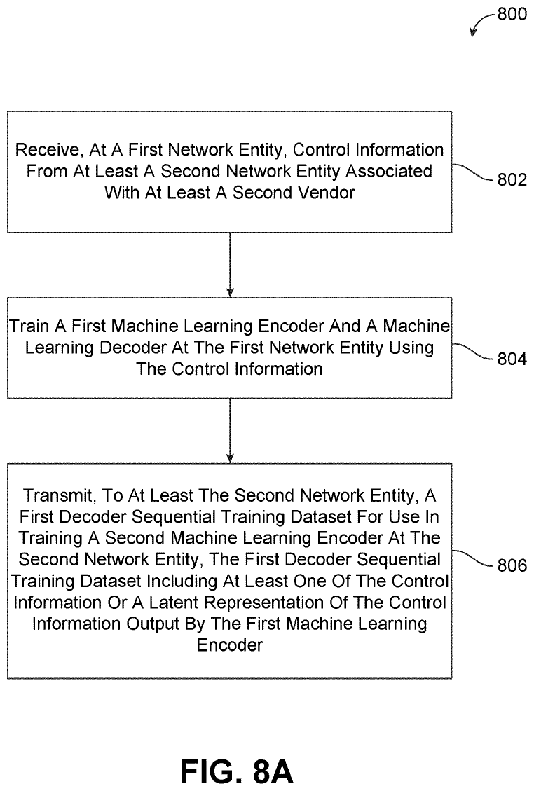

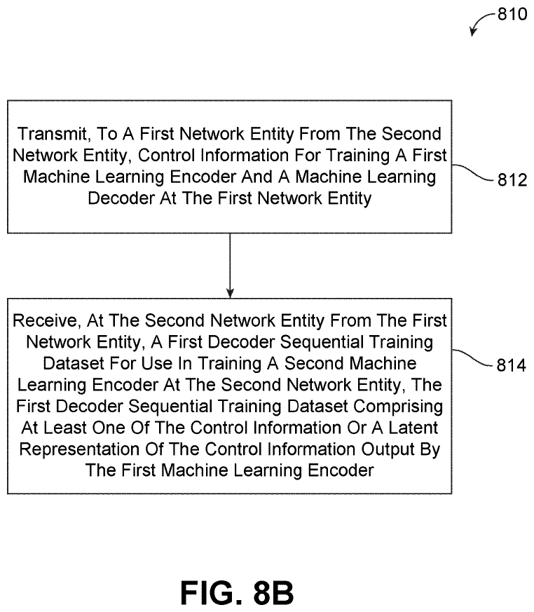

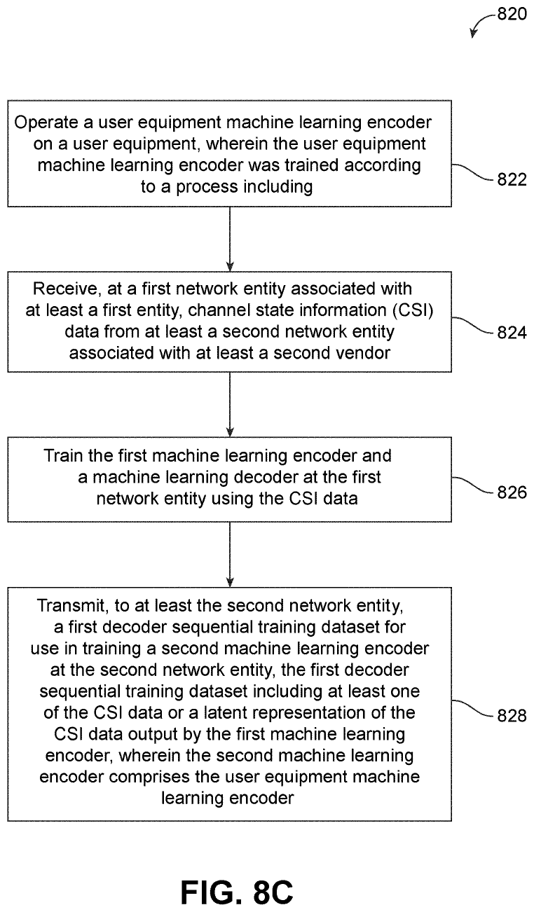

FIG. 8A is a flow diagram illustrating a process 800 for performing wireless communications. An example process or method 800 for wireless communications at a first network entity associated with a first vendor can include one or more steps of receiving, at the first network entity, control information from at least a second network entity associated with at least a second vendor (802), training a first machine learning encoder and a machine learning decoder at the first network entity using the control information (804) and transmitting, to at least the second network entity, a first decoder sequential training dataset for use in training a second machine learning encoder at the second network entity, the first decoder sequential training dataset including at least one of the control information or a latent representation of the control information output by the first machine learning encoder (806). The control information can include various types of information such as channel state information (CSI) and/or channel state feedback (CSF) or other types of information.

The machine learning decoder at the first network entity can be trained to be a shared decoder for decoding respective latent representations of the control information from multiple different machine learning encoders. The method 800 can further include transmitting, to a third network entity, the first decoder sequential training dataset for training a third machine learning encoder at the third network entity. The second network entity and the third network entity can represent different UEs having respective encoders.

In one aspect, the second machine learning encoder and the third machine learning encoder can be different types of machine learning encoders. The machine learning decoder can be trained to decode respective latent representations of control information from the first machine learning encoder and the second machine learning encoder. The first network entity can include a base station and the second network entity comprises a UE or mobile device. The first network entity can include a server associated with a base station and the second network entity can include a server associated with a UE. In one aspect, training the first machine learning encoder and the machine learning decoder at the first network entity can include minimizing an error based on a comparison of the control information and a decoded representation of the control information output by the machine learning decoder. There are different types of error that can be used and one example is a mean square error. The first decoder sequential training dataset can include the control information and the latent representation of the control information output by the first machine learning encoder. control information represents one example of data or information that can be used and other data or information is contemplated as well.

In another aspect, the method 800 can further include transmitting, to at least the second network entity, a reference decoder for use in training the second machine learning encoder based on the first decoder sequential training dataset. The reference decoder enables the second network entity to train the second machine learning encoder based on an end-to-end loss between the control information and a decoded representation of the control information output by the reference decoder. The first decoder sequential training dataset can include the control information and does not comprise the latent representation of the control information output by the first machine learning encoder. The first decoder sequential training dataset can include the control information, the latent representation of the control information output by the first machine learning encoder, and a decoded representation of the control information output by the machine learning decoder. The control information and the latent representation of the control information output by the first machine learning encoder can enable the second network entity to train a machine learning decoder and the second machine learning encoder at the second network entity.

In another aspect, method 800 can include receiving, from the second network entity, an encoder sequential training dataset and updating, based on the encoder sequential training dataset, the machine learning decoder at the first network entity to generate a second decoder sequential training dataset.

In another aspect, the method 800 can further include transmitting, from the first network entity to the second network entity, the second decoder sequential training dataset.

The step of updating, based on the encoder sequential training dataset, the machine learning decoder at the first network entity to generate the second decoder sequential training dataset further can include training at least one pre-processing layer at the first network entity based on the encoder sequential training dataset.

Weights of the machine learning decoder can be fixed during training the at least one pre-processing layer. In another aspect, the weights of the machine learning decoder can be updated during training the at least one pre-processing layer. The method 800 can also further include receiving multiple encoder sequential training datasets from different network entities and concatenating and mapping the multiple encoder sequential training datasets to an original latent dimension to train the machine learning decoder to function with multiple different machine learning encoders.

An apparatus for wireless communications can include at least one memory and at least one processor coupled to the at least one memory. The at least one process can be configured to: receive, at a first network entity (which can be the apparatus and can be associated with a first vendor), control information from at least a second network entity associated with at least a second vendor, train a first machine learning encoder and a machine learning decoder at the first network entity using the control information and transmit, to at least the second network entity, a first decoder sequential training dataset for use in training a second machine learning encoder at the second network entity, the first decoder sequential training dataset including at least one of the control information or a latent representation of the control information output by the first machine learning encoder.

The machine learning decoder at the first network entity can be trained to be a shared decoder for decoding respective latent representations of the control information from multiple different machine learning encoders. The at least one processor coupled to the at least one memory can further be configured to: transmit, to a third network entity, the first decoder sequential training dataset for training a third machine learning encoder at the third network entity.

The second machine learning encoder and the third machine learning encoder can be different types of machine learning encoders, and wherein the machine learning decoder is trained to decode respective latent representations of control information from the first machine learning encoder and the second machine learning encoder. The first network entity comprises a base station and the second network entity can include a UE or can represent multiple UEs.

FIG. 8B illustrates a method 810 for wireless communications between a first network entity associated with a first vendor and a second network entity associated with a second vendor. The method 810 can include one or more of transmitting, to the first network entity and from the second network entity, control information, wherein the first network entity trains a first machine learning encoder and a machine learning decoder using the control information (812) and receiving, at least the second network entity, a first decoder sequential training dataset for use in training a second machine learning encoder at the second network entity, the first decoder sequential training dataset comprising at least one of the control information or a latent representation of the control information output by the first machine learning encoder (814). The machine learning decoder at the first network entity can be trained to be a shared decoder for decoding respective latent representations of the control information from multiple different machine learning encoders. The control information can include various types of information such as channel state information (CSI) and/or channel state feedback (CSF) or other types of information.

The method 810 can further include transmitting, to a third network entity, the first decoder sequential training dataset for training a third machine learning encoder at the third network entity.

The second machine learning encoder and the third machine learning encoder can be different types of machine learning encoders. The machine learning decoder also can be trained to decode respective latent representations of control information from the first machine learning encoder and the second machine learning encoder. The first network entity can include a base station and the second network entity can include a UE.

An apparatus for wireless communications can include at least one memory and at least one processor coupled to the at least one memory. The at least one processor can be configured to transmit, to a network entity and from the apparatus, control information, wherein the network entity trains a first machine learning encoder and a machine learning decoder using the control information and receive, at least at the apparatus, a first decoder sequential training dataset for use in training a second machine learning encoder at the apparatus, the first decoder sequential training dataset including at least one of the control information or a latent representation of the control information output by the first machine learning encoder. The machine learning decoder at the network entity can be trained to be a shared decoder for decoding respective latent representations of the control information from multiple different machine learning encoders. The at least one processor coupled to the at least one memory can be further configured to transmit, to a second network entity, the first decoder sequential training dataset for training a third machine learning encoder at the second network entity.

The second machine learning encoder and the third machine learning encoder can be different types of machine learning encoders. The machine learning decoder can be trained to decode respective latent representations of control information from the first machine learning encoder and the second machine learning encoder. The network entity can be a base station and the apparatus can be a UE.

FIG. 8C illustrates a method 820 which can include one or more steps of operating a user equipment machine learning encoder on a user equipment (822). The user equipment machine learning encoder was trained according to a process including receiving, at a first network entity associated with at least a first entity, control information from at least a second network entity associated with at least a second vendor (824), training the first machine learning encoder and a machine learning decoder at the first network entity using the control information (826) and transmitting, to at least the second network entity, a first decoder sequential training dataset for use in training a second machine learning encoder at the second network entity, the first decoder sequential training dataset including at least one of the control information or a latent representation of the control information output by the first machine learning encoder, wherein the second machine learning encoder comprises the user equipment machine learning encoder (828).

An apparatus for wireless communications can include at least one memory and at least one processor coupled to the at least one memory. The at least one processor can be configured to operate a user equipment machine learning encoder on a user equipment, wherein the user equipment machine learning encoder was trained according to a process including: receiving, at a first network entity associated with at least a first entity, control information from at least a second network entity associated with at least a second vendor, training the first machine learning encoder and a machine learning decoder at the first network entity using the control information and transmitting, to at least the second network entity, a first decoder sequential training dataset for use in training a second machine learning encoder at the second network entity, the first decoder sequential training dataset including at least one of the control information or a latent representation of the control information output by the first machine learning encoder, wherein the second machine learning encoder comprises the user equipment machine learning encoder. The control information can include various types of information such as channel state information (CSI) and/or channel state feedback (CSF) or other types of information.

The UE embodiment which receives and deploys a trained encoder can utilize any encoder trained according to the various training approaches disclosed herein. Similarly, a gNB embodiment can receive and deploy any decoder trained according to any training approach disclosed herein.

A non-transitory computer-readable storage medium can include instructions stored thereon which, when executed by at least one processor, causes the at least one processor to perform any method, process or set of operations disclosed above.

An apparatus for wireless communications can include one or more means for performing operations according to any method, process or set of operations disclosed above.

In some examples, the processes described herein (e.g., process 800, 810 and 820 and/or other process described herein) may be performed by a computing device or apparatus (e.g., a UE or a base station). In another example, the processes 800, 810, 820 may be performed by the UE 104 of FIG. 1. In another example, the processes 800, 810, 820 may be performed by a base station 102 of FIG. 1.

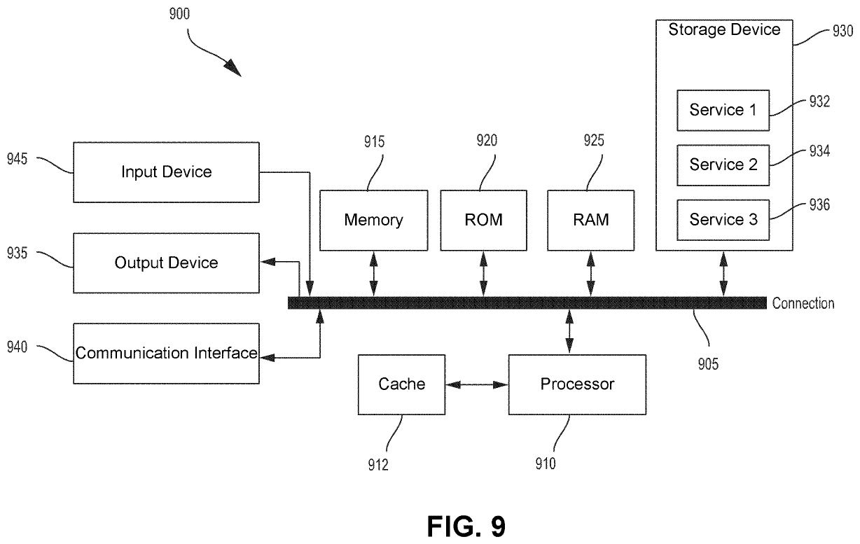

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 912 of high-speed memory connected directly with, in close proximity to, or integrated as part of processor 910.

Processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. A method of wireless communications at a first network entity associated with a first vendor, the method comprising: receiving, at the first network entity, control information from at least a second network entity associated with at least a second vendor; training a first machine learning encoder and a machine learning decoder at the first network entity using the control information; and transmitting, to at least the second network entity, a first decoder sequential training dataset for use in training a second machine learning encoder at the second network entity, the first decoder sequential training dataset including at least one of the control information or a latent representation of the control information output by the first machine learning encoder.

Aspect 2. The method of Aspect 1, wherein the machine learning decoder at the first network entity is trained to be a shared decoder for decoding respective latent representations of the control information from multiple different machine learning encoders.

Aspect 3. The method of any of Aspects 1 to 2, further comprising: transmitting, to a third network entity, the first decoder sequential training dataset for training a third machine learning encoder at the third network entity.

Aspect 4. The method of any of Aspects 1 to 3, wherein the second machine learning encoder and the third machine learning encoder are different types of machine learning encoders, and wherein the machine learning decoder is trained to decode respective latent representations of control information from the first machine learning encoder and the second machine learning encoder.

Aspect 5. The method of any of Aspects 1 to 4, wherein the first network entity comprises a base station and the second network entity comprises a user equipment.

Aspect 6. The method of any of Aspects 1 to 5, wherein the first network entity comprises a server associated with a base station and the second network entity comprises a server associated with a user equipment.

Aspect 7. The method of any of Aspects 1 to 6, wherein training the first machine learning encoder and the machine learning decoder at the first network entity includes minimizing an error based on a comparison of the control information and a decoded representation of the control information output by the machine learning decoder.

Aspect 8. The method of any of Aspects 1 to 7, wherein the error comprises a mean square error.

Aspect 9. The method of any of Aspects 1 to 8, wherein the first decoder sequential training dataset comprises the control information and the latent representation of the control information output by the first machine learning encoder.

Aspect 10. The method of any of Aspects 1 to 9, further comprising: transmitting, to at least the second network entity, a reference decoder for use in training the second machine learning encoder based on the first decoder sequential training dataset.

Aspect 11. The method of any of Aspects 1 to 10, wherein the reference decoder enables the second network entity to train the second machine learning encoder based on an end-to-end loss between the control information and a decoded representation of the control information output by the reference decoder.

Aspect 12. The method of any of Aspects 1 to 11, wherein the first decoder sequential training dataset comprises the control information and does not comprise the latent representation of the control information output by the first machine learning encoder.

Aspect 13. The method of any of Aspects 1 to 12, wherein the first decoder sequential training dataset comprises the control information, the latent representation of the control information output by the first machine learning encoder, and a decoded representation of the control information output by the machine learning decoder.

Aspect 14. The method of any of Aspects 1 to 13, wherein the control information and the latent representation of the control information output by the first machine learning encoder enable the second network entity to train a machine learning decoder and the second machine learning encoder at the second network entity.

Aspect 15. The method of any of Aspects 1 to 14, further comprising: receiving, from the second network entity, an encoder sequential training dataset; and updating, based on the encoder sequential training dataset, the machine learning decoder at the first network entity to generate a second decoder sequential training dataset.

Aspect 16. The method of any of Aspects 1 to 15, further comprising: transmitting, from the first network entity to the second network entity, the second decoder sequential training dataset.

Aspect 17. The method of any of Aspects 1 to 16, wherein updating, based on the encoder sequential training dataset, the machine learning decoder at the first network entity to generate the second decoder sequential training dataset further comprises training at least one pre-processing layer at the first network entity based on the encoder sequential training dataset.

Aspect 18. The method of any of Aspects 1 to 17, wherein weights of the machine learning decoder are fixed during training the at least one pre-processing layer.

Aspect 19. The method of any of Aspects 1 to 18, wherein weights of the machine learning decoder are updated during training the at least one pre-processing layer.

Aspect 20. The method of any of Aspects 1 to 19, further comprising: receiving multiple encoder sequential training datasets from different network entities; and concatenating and mapping the multiple encoder sequential training datasets to an original latent dimension to train the machine learning decoder to function with multiple different machine learning encoders.

Aspect 21. The method of any of Aspects 1 to 20, wherein the control information comprises channel state information (CSI) or channel state feedback (CSF).

Aspect 22. A first network entity associated with a first vendor and for wireless communications, comprising: at least one memory; and at least one processor coupled to the at least one memory and configured to: receive control information from at least a second network entity associated with at least a second vendor; train a first machine learning encoder and a machine learning decoder at the first network entity using the control information; and transmit, to at least the second network entity, a first decoder sequential training dataset for use in training a second machine learning encoder at the second network entity, the first decoder sequential training dataset including at least one of the control information or a latent representation of the control information output by the first machine learning encoder.

Aspect 23. The first network entity of Aspect 22, wherein the at least one processor is configured to train the machine learning decoder at the first network entity to be a shared decoder for decoding respective latent representations of the control information from multiple different machine learning encoders.

Aspect 24. The first network entity of any of Aspects 22 to 23, wherein the at least one processor is further configured to: transmit, to a third network entity, the first decoder sequential training dataset for training a third machine learning encoder at the third network entity.

Aspect 25. The first network entity of any of Aspects 22 to 24, wherein the second machine learning encoder and the third machine learning encoder are different types of machine learning encoders, and wherein the machine learning decoder is trained to decode respective latent representations of control information from the first machine learning encoder and the second machine learning encoder.

Aspect 26. The first network entity of any of Aspects 22 to 25, wherein the first network entity comprises a base station and the second network entity comprises a user equipment.

Aspect 27. The first network entity of any of Aspects 22 to 26, wherein the first network entity comprises a server associated with a base station and the second network entity comprises a server associated with a user equipment.

Aspect 28. The first network entity of any of Aspects 22 to 27, wherein, to train the first machine learning encoder and the machine learning decoder at the first network entity, the at least one processor is configured to minimize an error based on a comparison of the control information and a decoded representation of the control information output by the machine learning decoder.

Aspect 29. The first network entity of any of Aspects 22 to 28, wherein the error comprises a mean square error.

Aspect 30. The first network entity of any of Aspects 22 to 29, wherein the first decoder sequential training dataset comprises the control information and the latent representation of the control information output by the first machine learning encoder.

Aspect 31. The first network entity of any of Aspects 22 to 30, wherein the at least one processor is configured to: transmit, to at least the second network entity, a reference decoder for use in training the second machine learning encoder based on the first decoder sequential training dataset.

Aspect 32. The first network entity of any of Aspects 22 to 31, wherein the reference decoder enables the second network entity to train the second machine learning encoder based on an end-to-end loss between the control information and a decoded representation of the control information output by the reference decoder.

Aspect 33. The first network entity of any of Aspects 22 to 32, wherein the first decoder sequential training dataset comprises the control information and does not comprise the latent representation of the control information output by the first machine learning encoder.

Aspect 34. The first network entity of any of Aspects 22 to 33, wherein the first decoder sequential training dataset comprises the control information, the latent representation of the control information output by the first machine learning encoder, and a decoded representation of the control information output by the machine learning decoder.

Aspect 35. The first network entity of any of Aspects 22 to 34, wherein the control information and the latent representation of the control information output by the first machine learning encoder enable the second network entity to train a machine learning decoder and the second machine learning encoder at the second network entity.

Aspect 36. The first network entity of any of Aspects 22 to 35, wherein the at least one processor is configured to: receive, from the second network entity, an encoder sequential training dataset; and update, based on the encoder sequential training dataset, the machine learning decoder at the first network entity to generate a second decoder sequential training dataset.

Aspect 37. The first network entity of any of Aspects 22 to 36, wherein the at least one processor is configured to: transmit, from the first network entity to the second network entity, the second decoder sequential training dataset.

Aspect 38. The first network entity of any of Aspects 22 to 37, wherein, to update the machine learning decoder at the first network entity based on the encoder sequential training dataset to generate the second decoder sequential training dataset, the at least one processor is further configured to train at least one pre-processing layer at the first network entity based on the encoder sequential training dataset.

Aspect 39. The first network entity of any of Aspects 22 to 38, wherein weights of the machine learning decoder are fixed during training the at least one pre-processing layer.

Aspect 40. The first network entity of any of Aspects 22 to 39, wherein weights of the machine learning decoder are updated during training the at least one pre-processing layer.

Aspect 41. The first network entity of any of Aspects 22 to 40, wherein the at least one processor is configured to: receive multiple encoder sequential training datasets from different network entities; and concatenate and mapping the multiple encoder sequential training datasets to an original latent dimension to train the machine learning decoder to function with multiple different machine learning encoders.

Aspect 42. The first network entity of any of Aspects 22 to 41, wherein the control information comprises channel state information (CSI) or channel state feedback (CSF).

Aspect 43. A method of wireless communications between a first network entity associated with a first vendor and a second network entity associated with a second vendor, the method comprising: transmitting, to the first network entity and from the second network entity, control information for training a first machine learning encoder and a machine learning decoder at the first network entity; and receiving, at the second network entity from the first network entity, a first decoder sequential training dataset for use in training a second machine learning encoder at the second network entity, the first decoder sequential training dataset comprising at least one of the control information or a latent representation of the control information output by the first machine learning encoder.

Aspect 44. The method of Aspect 43, wherein the machine learning decoder at the first network entity is trained to be a shared decoder for decoding respective latent representations of the control information from multiple different machine learning encoders.

Aspect 45. The method of any of Aspects 43 to 44, further comprising: transmitting, to a third network entity, the first decoder sequential training dataset for training a third machine learning encoder at the third network entity.

Aspect 46. The method of any of Aspects 43 to 45, wherein the second machine learning encoder and the third machine learning encoder are different types of machine learning encoders, and wherein the machine learning decoder is trained to decode respective latent representations of control information from the first machine learning encoder and the second machine learning encoder.

Aspect 47. The method of any of Aspects 43 to 46, wherein the first network entity comprises a base station and the second network entity comprises a user equipment.

Aspect 48. The method of any of Aspects 43 to 47, wherein the control information comprises channel state information (CSI) or channel state feedback (CSF).

Aspect 49. An apparatus for wireless communications, comprising: at least one memory; and at least one processor coupled to the at least one memory and configured to: transmit, to a network entity, control information for training a first machine learning encoder and a machine learning decoder at the network entity; and receive, from the network entity, a first decoder sequential training dataset for use in training a second machine learning encoder at the apparatus, the first decoder sequential training dataset comprising at least one of the control information or a latent representation of the control information output by the first machine learning encoder.

Aspect 50. The apparatus of Aspect 49, wherein the at least one processor is configured to train the machine learning decoder at the network entity to be a shared decoder for decoding respective latent representations of the control information from multiple different machine learning encoders.

Aspect 51. The apparatus of any of Aspects 49 to 50, wherein the at least one processor is further configured to: transmit, to a second network entity, the first decoder sequential training dataset for training a third machine learning encoder at the second network entity.

Aspect 52. The apparatus of any of Aspects 49 to 51, wherein the second machine learning encoder and the third machine learning encoder are different types of machine learning encoders, and wherein the machine learning decoder is trained to decode respective latent representations of control information from the first machine learning encoder and the second machine learning encoder.

Aspect 53. The apparatus of any of Aspects 49 to 52, wherein the network entity comprises a base station and the apparatus comprises a user equipment.

Aspect 54. The apparatus of any of Aspects 49 to 53, wherein the control information comprises channel state information (CSI) or channel state feedback (CSF).

Aspect 55. A non-transitory computer-readable storage medium comprising instructions stored thereon which, when executed by at least one processor, causes the at least one processor to perform operations according to any of Aspects 1-42 and/or claims 43-54.

Aspect 56. An apparatus for wireless communications comprising one or more means for performing operations according to any of Aspects 1-42 and/or claims 43-54.

1. A method of wireless communications at a first network entity associated with a first vendor, the method comprising:
receiving, at the first network entity, control information from at least a second network entity associated with at least a second vendor;
training a first machine learning encoder and a machine learning decoder at the first network entity using the control information; and
transmitting, to at least the second network entity, a first decoder sequential training dataset for use in training a second machine learning encoder at the second network entity, the first decoder sequential training dataset including at least one of the control information or a latent representation of the control information output by the first machine learning encoder.

2. The method of claim 1, wherein the machine learning decoder at the first network entity is trained to be a shared decoder for decoding respective latent representations of the control information from multiple different machine learning encoders.

3. The method of claim 1, further comprising:
transmitting, to a third network entity, the first decoder sequential training dataset for training a third machine learning encoder at the third network entity.

4-6. (canceled)

7. The method of claim 1, wherein training the first machine learning encoder and the machine learning decoder at the first network entity includes minimizing an error based on a comparison of the control information and a decoded representation of the control information output by the machine learning decoder.

8-9. (canceled)

10. The method of claim 1, further comprising:
transmitting, to at least the second network entity, a reference decoder for use in training the second machine learning encoder based on the first decoder sequential training dataset, wherein the reference decoder enables the second network entity to train the second machine learning encoder based on an end-to-end loss between the control information and a decoded representation of the control information output by the reference decoder.

11-14. (canceled)

15. The method of claim 1, further comprising:
receiving, from the second network entity, an encoder sequential training dataset; and
updating, based on the encoder sequential training dataset, the machine learning decoder at the first network entity to generate a second decoder sequential training dataset.

16-20. (canceled)

21. The method of claim 1, wherein the control information comprises channel state information (CSI) or channel state feedback (CSF).

22. A first network entity associated with a first vendor and for wireless communications, comprising:
at least one memory; and
at least one processor coupled to the at least one memory and configured to:
receive control information from at least a second network entity associated with at least a second vendor;
train a first machine learning encoder and a machine learning decoder at the first network entity using the control information; and
transmit, to at least the second network entity, a first decoder sequential training dataset for use in training a second machine learning encoder at the second network entity, the first decoder sequential training dataset including at least one of the control information or a latent representation of the control information output by the first machine learning encoder.

23. The first network entity of claim 22, wherein the at least one processor is configured to train the machine learning decoder at the first network entity to be a shared decoder for decoding respective latent representations of the control information from multiple different machine learning encoders.

24. The first network entity of claim 22, wherein the at least one processor is further configured to:
transmit, to a third network entity, the first decoder sequential training dataset for training a third machine learning encoder at the third network entity.

25. The first network entity of claim 24, wherein the second machine learning encoder and the third machine learning encoder are different types of machine learning encoders, and wherein the machine learning decoder is trained to decode respective latent representations of control information from the first machine learning encoder and the second machine learning encoder.

26. The first network entity of claim 22, wherein the first network entity comprises a base station and the second network entity comprises a user equipment.

27. The first network entity of claim 22, wherein the first network entity comprises a server associated with a base station and the second network entity comprises a server associated with a user equipment.

28. The first network entity of claim 22, wherein, to train the first machine learning encoder and the machine learning decoder at the first network entity, the at least one processor is configured to minimize an error based on a comparison of the control information and a decoded representation of the control information output by the machine learning decoder.

29. The first network entity of claim 28, wherein the error comprises a mean square error.

30. The first network entity of claim 22, wherein the first decoder sequential training dataset comprises the control information and the latent representation of the control information output by the first machine learning encoder.

31. The first network entity of claim 22, wherein the at least one processor is configured to:
transmit, to at least the second network entity, a reference decoder for use in training the second machine learning encoder based on the first decoder sequential training dataset.

32. The first network entity of claim 31, wherein the reference decoder enables the second network entity to train the second machine learning encoder based on an end-to-end loss between the control information and a decoded representation of the control information output by the reference decoder.

33. The first network entity of claim 31, wherein the first decoder sequential training dataset comprises the control information and does not comprise the latent representation of the control information output by the first machine learning encoder.

34. The first network entity of claim 22, wherein the first decoder sequential training dataset comprises the control information, the latent representation of the control information output by the first machine learning encoder, and a decoded representation of the control information output by the machine learning decoder.

35. The first network entity of claim 34, wherein the control information and the latent representation of the control information output by the first machine learning encoder enable the second network entity to train a machine learning decoder and the second machine learning encoder at the second network entity.

36. The first network entity of claim 22, wherein the at least one processor is configured to:
receive, from the second network entity, an encoder sequential training dataset; and
update, based on the encoder sequential training dataset, the machine learning decoder at the first network entity to generate a second decoder sequential training dataset.

37. The first network entity of claim 36, wherein the at least one processor is configured to:
transmit, from the first network entity to the second network entity, the second decoder sequential training dataset.

38. The first network entity of claim 36, wherein, to update the machine learning decoder at the first network entity based on the encoder sequential training dataset to generate the second decoder sequential training dataset, the at least one processor is further configured to train at least one pre-processing layer at the first network entity based on the encoder sequential training dataset.

39. The first network entity of claim 38, wherein weights of the machine learning decoder are fixed during training the at least one pre-processing layer.

40. The first network entity of claim 38, wherein weights of the machine learning decoder are updated during training the at least one pre-processing layer.

41. The first network entity of claim 38, wherein the at least one processor is configured to:
receive multiple encoder sequential training datasets from different network entities; and
concatenate and mapping the multiple encoder sequential training datasets to an original latent dimension to train the machine learning decoder to function with multiple different machine learning encoders.

42. The first network entity of claim 22, wherein the control information comprises channel state information (CSI) or channel state feedback (CSF).

43. A method of wireless communications between a first network entity associated with a first vendor and a second network entity associated with a second vendor, the method comprising:
transmitting, to the first network entity and from the second network entity, control information for training a first machine learning encoder and a machine learning decoder at the first network entity; and
receiving, at the second network entity from the first network entity, a first decoder sequential training dataset for use in training a second machine learning encoder at the second network entity, the first decoder sequential training dataset comprising at least one of the control information or a latent representation of the control information output by the first machine learning encoder.

44-48. (canceled)

49. An apparatus for wireless communications, comprising:
at least one memory; and
at least one processor coupled to the at least one memory and configured to:
transmit, to a network entity, control information for training a first machine learning encoder and a machine learning decoder at the network entity; and
receive, from the network entity, a first decoder sequential training dataset for use in training a second machine learning encoder at the apparatus, the first decoder sequential training dataset comprising at least one of the control information or a latent representation of the control information output by the first machine learning encoder.

50-56. (canceled)
